(19) United States
(12) Patent Application Publication
(10) Pub. No.: US 2024/0210368 A1
(43) Pub. Date: Jun. 27, 2024

(54) SENSOR ELEMENT FOR AN OPTOCHEMICAL SENSOR

(71) Applicant: Endress+Hauser Conducta GmbH+Co. KG, Gerlingen (DE)

(72) Inventors: Andreas Löbbert, Waldheim (DE); Matthäus Speck, Göpfersdorf (DE); Katrin Scholz, Bobritzsch (DE); Alexander Hörig, Geringswalde (DE)

(21) Appl. No.: 18/543,888

(22) Filed: Dec. 18, 2023

(30) Foreign Application Priority Data
Dec. 21, 2022 (DE) 10 2022 134 274.3

(51) Int. Cl. G01N 31/22; G01N 21/64; G01N 21/76

(52) U.S. Cl. CPC G01N 31/225; G01N 21/643; G01N 21/76; G01N 2021/6432; G01N 2021/6434; G01N 2201/08; G01N 2223/638

(57) ABSTRACT

A sensor element for an optochemical sensor includes: a luminescence indicator, whose luminescence can be quenched with oxygen; and scavenger units to deactivate singlet oxygen, forming a chemical reaction product by reacting with singlet oxygen, wherein the scavenger units are selected to be recovered by a decomposition reaction induced thermally, photochemically or by a pressure increase of the chemical reaction product formed by the reaction with singlet oxygen.

### CROSS-REFERENCE TO RELATED APPLICATION

The present application is related to and claims the priority benefit of German Patent Application No. 10 2022 134 274.3, filed Dec. 21, 2022, the entire contents of which are incorporated herein by reference.

### TECHNICAL FIELD

The present disclosure relates to a sensor element for an optochemical sensor.

### BACKGROUND

Optochemical sensors (optodes), also referred to herein as optical sensors for the sake of simplicity, are used in a variety of applications in process analysis and in the laboratory. In a variety of cases, optical sensors are used to measure the concentration of oxygen, but in principle they can also be used to measure pH or reactive oxygen species (ROS), ozone, or glucose. The substance whose concentration is to be determined by means of an optical sensor is also referred to below as the analyte. Optodes have an indicator dye, often contained in a sensitive layer or membrane of a sensor element, that can be excited to luminescence (fluorescence or phosphorescence) by electromagnetic radiation, also referred to below as a luminescence indicator. For measurement, the sensitive layer or membrane is brought into contact with a measuring medium, for example, a measuring solution. The luminescence of the luminescence indicator is doused (quenched) by the analyte contained in the measuring medium, for example, oxygen. Thus, luminescence intensity and luminescence decay time decrease with increasing concentration of the analyte.

A problem often observed with optochemical sensors is the degenerative aging of the sensitive layer or the luminescence indicator contained therein, which is triggered by the irradiated excitation light. One cause of such aging may be chemical reactions of the luminescence indicator with singlet oxygen (¹Δ_{g}) formed by transfer of energy during the dousing of the luminescence. The singlet oxygen can also react with a polymer matrix in which the luminescence indicator is embedded or with other components of the sensitive layer or membrane. This problem of photo-induced aging occurs in particular if irradiation is at high intensity in order to improve signal quality or if the sensor is operated for long periods of time. The singlet oxygen can react directly or indirectly via intermediates with the luminescence indicator or other substances or functional groups present in the sensitive layer or membrane. For example, solvents can react with singlet oxygen and persist as longer-lived radicals in the system and react with a time delay. As a result, the properties of the luminescence indicator, such as the decay time, the intensity or the phase angle, change due to the formation of further, but also slightly different luminescent reaction products of the indicator molecule. This manifests itself in a drift of the sensor signal.

EP 907 074 B1 describes an optochemical sensor with a matrix and a luminescence indicator contained therein, the luminescence of which can be quenched with oxygen. The sensor has an agent that can deactivate singlet oxygen to stabilize the luminescence indicator and matrix. The agent can be bound to the matrix or luminescence indicator and can, for example, have an amino group or be a hindered amine light stabilizer (HALS) or transition metal complex. The cyclic amine, DABCO (1,4-diazabicyclo[2,2,2]octane), is reported as a possible additive to deactivate singlet oxygen. However, such additive, along with other additives proposed in EP 907 074 B1, can also influence the photophysical properties of the sensor and thus the measurement signal. This is classified as tolerable in EP 907 074 B1.

When the sensor is operated over a long period of time, the sensor membrane or layer can become depleted of additives. If the additives have an effect on the photophysical properties of the sensor, either because they luminesce themselves or because they douse the luminescence of the luminescence indicator, their change in concentration also affects sensor drift.

Accordingly, there remains a need for further contributions in this area of technology.

### SUMMARY

It is therefore the object of the present disclosure to provide an improved sensor element for an optochemical sensor, in particular, a sensor for determining the concentration of oxygen or oxygen-containing species in a measuring medium. In particular, the sensor element should enable high stability of the sensor signal over a long period of time.

This aim is achieved by a sensor element and an optochemical sensor according to the present disclosure.

The sensor element according to the present disclosure for an optochemical sensor comprises:
a luminescence indicator, whose luminescence can be quenched with oxygen, and
scavenger units to deactivate singlet oxygen, forming a chemical reaction product by reacting with singlet oxygen,
wherein the scavenger units are selected to be recovered by a decomposition reaction induced thermally, photochemically or by a pressure increase of the chemical reaction product formed by the reaction with singlet oxygen.

The sensor element can comprise a sensitive layer containing the luminescence indicator and optionally other layers. The layers can be applied to a support, but it is also possible for the layer or layers to form a self-supporting membrane. The sensitive layer and, if necessary, other layers can also be arranged on an end face of an optical fiber.

The sensor element or a sensitive layer of the sensor element thus contains scavenger units that react, in particular exclusively, with singlet oxygen to form stable, preferably non-polar, compounds, wherein such compounds split off oxygen again due to a physical influence such as pressure or temperature and return to their original state (as scavenger units). In this way, the singlet oxygen is bound in a controlled manner and can be released again with a time delay in regeneration phases, in which a temperature threshold or a pressure threshold is exceeded. Advantageously, the scavenger units can be selected such that the temperature or pressure values at which the reverse reaction occurs to form the original scavenger unit and release oxygen are achieved during a sterilization process, an autoclaving process or a cleaning process. In this way, a regeneration of scavenger units “consumed” by reaction with singlet oxygen occurs simultaneously during the intermediate sterilization or cleaning of the optochemical sensor with the sensor element, for example, sterilization in place (SIP) or cleaning in place (CIP), without a user having to take additional measures for regeneration of the sensing membrane.

Such regenerability of the sensor element or the sensitive layer enables the stable sensor operation of an optochemical sensor with the sensor element according to the present disclosure over a long period of time. Since singlet oxygen is bound by the scavenger units and is only released again with a time delay by heating, pressure increase or photochemically, the singlet oxygen is present at any time in such a low concentration in the sensitive layer that reactions leading to a chemical change in the luminescence indicator and aging of the sensitive layer take place to a considerably lesser extent.

The sensor element, in particular a sensitive layer of the sensor element, can have a polymer matrix, in which the luminescence indicator is present, for example in the form of a mixture or bound to the polymer matrix or encapsulated in micelles or core-shell structures contained in the polymer matrix.

In one possible embodiment, the scavenger units can be bonded to the polymer matrix.
Additionally or alternatively, the scavenger units can be bound to the luminescence indicator.

In another possible embodiment, the sensor element, in particular a sensitive layer of the sensor element, can have micelles in which the luminescence indicator is encapsulated. In this case, the scavenger units can be bound to a material forming the micelles or to the luminescence indicator. The micelles can be incorporated into a polymer matrix, either in the sense of a mixture of the polymer and the micelles or by a chemical bond to the polymer matrix. However, it is also possible that the micelles are fixed to a substrate, for example a surface of a glass plate or quartz plate as a support or a light guide, and thus form the sensitive layer of the sensor element. In this case, the sensor element or sensitive layer can do without a polymer matrix.

In another possible embodiment, the sensor element, in particular a sensitive layer of the sensor element, can have core-shell particles, in which the luminescence indicator is encapsulated. In this case, the scavenger units can be bound to a material forming the shell, such as a polymer forming the shell, or to the luminescence indicator. As with the embodiment described above, with which the sensor element or a sensitive layer of the sensor element has micelles in which the luminescence indicator is encapsulated, the core-shell particles can also be incorporated into a polymer matrix. Alternatively, the core-shell particles can be fixed to a substrate, such as a glass substrate or quartz substrate serving as a support, or to a surface of an optical fiber.

Alternatively, it is also possible that the scavenger units are encapsulated in micelles or core-shell particles and/or bound to a material forming the micelles or the shell. The luminescence indicator can also be encapsulated or free in a sensor membrane or sensitive layer of the sensor element. The micelles or core-shell particles along with the indicator can be bound in a polymer matrix or can be present in mixture with the polymer matrix.

In another possible embodiment, the sensor element can have a self-assembled monolayer (SAM) of surface-active molecules, wherein the scavenger units are bound to at least a portion of the surface-active molecules forming the monolayer or to the luminescence indicator.

In all of these embodiments, the scavenger units can be bound to the luminescence indicator or polymer matrix, or to the aforementioned micelles, core-shell structures or SAM-forming molecules, via spacer groups, for example, ether groups, alkyl groups, ethylene glycol or polyethylene glycol. The length of the spacer groups can be selected such that the distance of the scavenger units across the spacer groups from the luminescence indicator minimizes any influence of the scavenger units on its luminescence properties.

The scavenger units can be selected to bind singlet oxygen as the endoperoxide. The scavenger units can be, for example, polycyclic aromatic hydrocarbons or derivatives of polycyclic aromatic hydrocarbons, for example substituted polycyclic aromatic hydrocarbons. They can be selected from: substituted benzene derivatives, naphthalene and naphthalene derivatives, acenes, in particular anthracene, tetracene, pentacene and hexacene, substituted acenes and acene derivatives, preferably with methyl, phenyl, pyridinyl, alkynyl or tetramethylsilane (TMS) as substituents.

A possible substituted benzene derivative is, for example, hexamethylbenzene. Suitable acenes include 2,3-benzo(a)anthracene or substituted 2,3-benzo(a)anthracene or derivatives of 2,3-benzo(a)anthracene. Methyl-substituted 2-pyridone can also be considered as a scavenger unit.

The luminescence indicator can be selected from the following: metal-porphyrin complexes, or iodinated BODIPYs (e.g., iodinated boron-dipyrromethene, e.g., 4,4-difluoro-4-bora-3a,4a-diaza-s-indacene), metal phthalocyanines, halo(iodo)triangulenium complexes, platinum-organic complexes (acetylacetonato platinum complexes or cyclometalate-pyridyl-substituted coumarins), ruthenium phenanthrolines, difluoroboron or aluminum chelates of 9-hydroxyphenalenone and benzannelized derivatives of 6-hydroxybenz[de]anthracen-7-one.

The present disclosure also comprises an optochemical sensor, in particular for measuring a measured variable representing the concentration of oxygen or a reactive oxygen-containing species in a measuring medium, comprising a sensor element according to one of the embodiments described above, and a radiation source for exciting the luminescence indicator to emit luminescence radiation, in particular fluorescence or phosphorescence radiation, along with a detection device for recording at least one optical property of the luminescence indicator. For example, the optical property can be a luminescence intensity, a luminescence decay time or a phase angle.

### BRIEF DESCRIPTION OF THE DRAWINGS

In the following, the present disclosure is explained on the basis of the exemplary embodiments shown in the figures. The same reference signs refer to the same components of the components shown in the figures. In the figures:

FIG. 1 shows a schematic representation of an optochemical sensor with a sensor membrane;

FIG. 2 shows a schematic representation of possible chemical reaction pathways for photochemically induced aging of a luminescence indicator;

FIG. 3 shows an example of reversible binding of singlet oxygen by scavenger units bound to a luminescence indicator;

FIG. 4 shows further examples of scavenger units for binding to a luminescence indicator with scavenger units;

FIG. 5 shows a first example of a polymer matrix modified with scavenger units for reversible binding of singlet oxygen;

FIG. 6 shows a second example of a polymer matrix modified with scavenger units for reversible binding of singlet oxygen;

FIG. 7 shows examples of micelle materials modified with scavenger units for reversible binding of singlet oxygen;

FIG. 8 shows examples of SAM units modified with scavenger units for reversible binding of singlet oxygen; and

FIGS. 9a and 9b each show a schematic representation of the insertion of scavenger units into luminescence-indicator-containing pigment capsules (beads).

### DETAILED DESCRIPTION

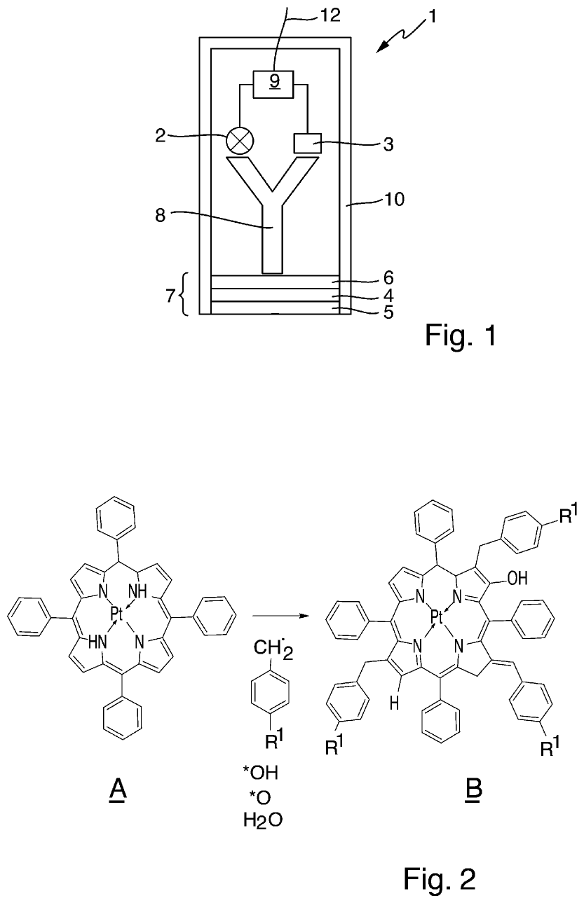

In FIG. 1, an optochemical sensor 1 for determining the concentration of an analyte in a measuring fluid, for example, dissolved oxygen in the measuring fluid, is shown schematically in a longitudinal sectional view. The sensor 1 comprises a radiation source 2 and a detector 3, along with a sensor element 7 comprising a sensitive layer 4. The sensitive layer 4 contains a luminescence indicator for detecting oxygen. For example, the sensitive layer 4 can have a matrix, such as a polymer matrix, in which the luminescence indicator is included, for example, in the form of a mixture with the polymer matrix or chemically bonded to the polymer matrix. The luminescence indicator can be excited to luminescence, for example, fluorescence, by radiation emitted from the radiation source 2. For this purpose, a wavelength of the radiation emitted by the radiation source 2 is selected to match the absorption spectrum of the luminescence indicator to excite it. The detector 3 is configured to record luminescence radiation emitted by the luminescence indicator and convert it into an electrical measurement signal. In the present example, the sensor element 7 comprises an optical insulating layer 5 and a transparent support 6 in addition to the sensitive layer 4. In alternative embodiments, the sensitive layer 4 and the optical insulating layer 5 can be designed as a membrane (sensor spot) arranged on a transparent support or as a self-supporting membrane or as a layer system on an end face of an optical fiber or a light guide. The sensor element 7 can have further layers, and/or the sensor element 7 can be a component of a replaceable housing cap of the optochemical sensor.

In the present example, radiation from the radiation source 2 is radiated to the sensor element 7 via a first branch of a light guide 8. Luminescence radiation emitted from the luminescence indicator reaches the detector 3 via a second branch of the light guide 8. The sensor 1 includes a sensor circuit 9 that is configured to control the light source 2 and to receive and process the electrical measurement signals from the detector 3. It can be connected via a cable connection 12 or wirelessly for communication with a higher-level unit, in order to output to it the measurement signals or values or signals derived from the measurement signals. In the present example, the sensor element 7, the optical fiber 8, the radiation source 2, the detector 3 and the sensor circuit 9 are housed in a probe housing 10.

In a measuring mode of the sensor 1, the sensor element 7 is brought into contact with a measuring medium, for example, with a measuring fluid containing oxygen. The luminescence indicator is excited to luminescence by excitation radiation from radiation source 2, which is quenched by oxygen in a concentration-dependent manner. The luminescence radiation is recorded in the detector 3 as an electrical measurement signal, for example, in the form of a decay time, an intensity or a phase angle. The oxygen concentration in the measuring fluid is determined from the recorded measuring signal. This can be performed in the sensor circuit 9 or in the higher-level unit connected to the sensor circuit 9, for example, a transducer or other electronic display or operating device. For the decay time or phase shift measurements, a radiation source 2 with temporal modulation of the intensity (e.g., pulse, sinusoidal or square-wave modulation) and a time-resolved or sensitivity-modulated detector 3 can be used.

During the excitation of the luminescence indicator, highly reactive singlet oxygen can be formed by transferring energy from the luminescence indicator to oxygen molecules present in the sensitive layer 4. This can react directly or indirectly via intermediates with the luminescence indicator or with other substances in the sensitive layer 4, for example, with the polymer matrix containing the luminescence indicator. As a result, optical properties of the luminescence indicator or sensitive layer 4 also change and thus a decay time or an intensity or a phase angle recorded by the detector 3 can also change.

FIG. 2 shows possible reaction pathways that can lead to degenerative aging of the luminescence indicator. In the present example, the luminescence indicator is a platinum-porphyrin complex A, whose luminescence can be doused by oxygen. Singlet oxygen can react directly with functional groups of the luminescence indicator. As shown in FIG. 2, however, singlet oxygen can also react with solvent molecules present in the sensitive layer 4 of the sensor element 7, in this case, for example, water or components of the sensitive layer, for example, a polymer matrix containing the luminescence indicator, to form highly reactive intermediates, for example, hydroxide, oxygen or benzyl radicals. Such radicals can in turn react with porphyrin complex A and be bound to the complex as additional functional groups. The modified porphyrin complex B formed in this way has different optical properties than the original porphyrin complex A. The more frequently such reactions occur in the sensitive layer 4 of the sensor 1, the more the measurement signal recorded by the detector is distorted, which ultimately leads to a drift of the sensor signal.

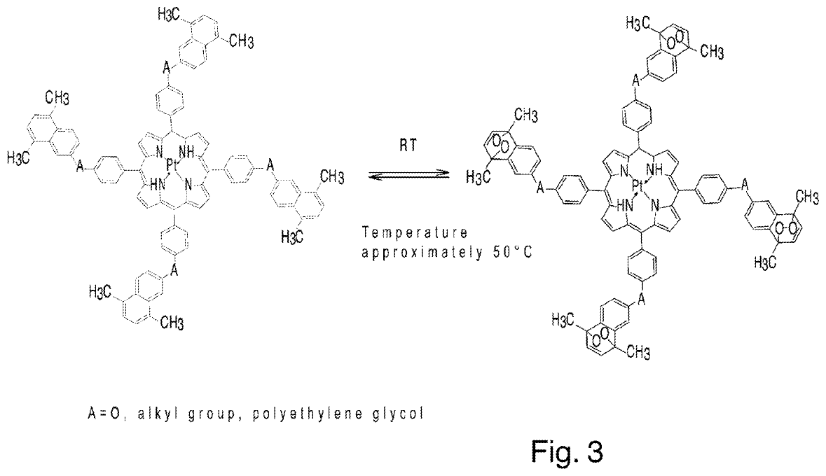

FIG. 3 illustrates an example of reversible binding of singlet oxygen by scavenger units bound to a luminescence indicator according to the present disclosure; a platinum-porphyrin complex is used here as the luminescence indicator, wherein the porphyrin is functionalized with phenyl groups, to each of which scavenger units are bound via a spacer unit A. Presently, the scavenger units are each formed from a naphthalene derivative. For example, the spacer unit A can be formed by an ether group, an alkyl group, ethylene glycol or polyethylene glycol. Singlet oxygen formed upon irradiation of sensitive layer 4 with excitation radiation is bound to polycyclic aromatics via a [4+2] cycloaddition, in this case to the scavenger units formed by the substituted naphthalene groups. The endoperoxide formed is stable up to temperatures of 50° C. If the temperature is increased above 50° C., the equilibrium of the reaction equation shown in FIG. 3 is on the left side, i.e., the reactant side. Thus, when the temperature rises above this threshold, for example, during a sterilization process where temperatures of 120° C. or more are reached, the oxygen bound to the scavenger units is released again and the scavenger units are regenerated. Even if singlet oxygen is released again in this way at elevated temperatures, this occurs with a time delay and in small amounts, such that the aging effects described on the basis of FIG. 2 occur to a much lesser extent if the luminescent dye is functionalized with scavenger units as shown in FIG. 3. Advantageously, longer-chain spacer groups A are used to minimize interference of the scavenger units with the luminescence properties of the luminescence indicator.

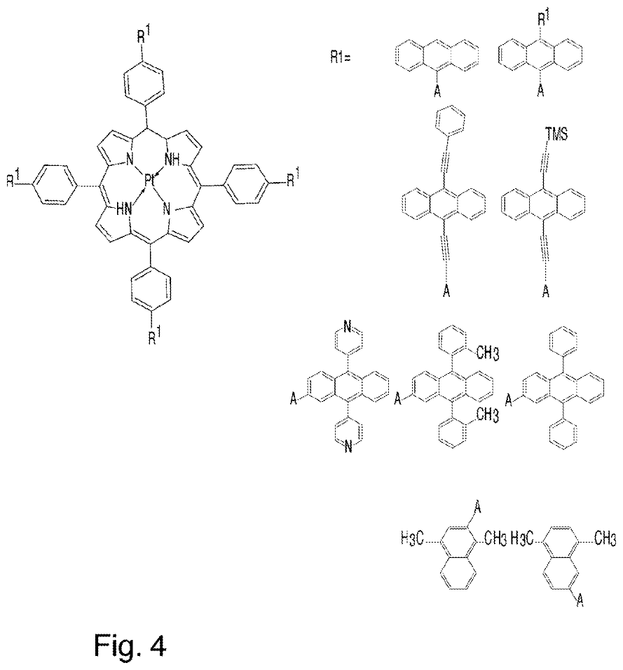

FIG. 4 shows further examples of scavenger units that can be used to reversibly bind singlet oxygen to the luminescence indicator. The scavenger units can be, in particular, substituted polycyclic aromatics, for example, the functionalized anthracenes and anthracene derivatives or functionalized naphthalenes and naphthalene derivatives shown herein. With the examples according to FIG. 4, the scavenger units are also bound to the luminescence indicator via spacer units A, which can be selected quite analogously as described with reference to FIG. 3.

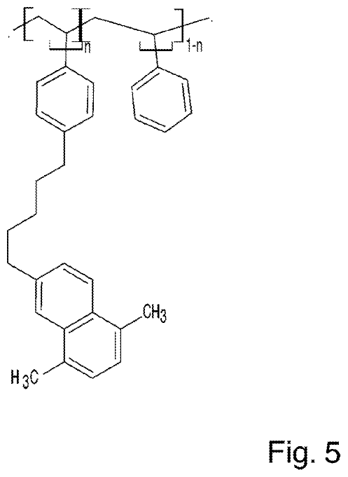

FIG. 5 shows a first example of a polymer matrix modified with scavenger units for the reversible binding of singlet oxygen. The polymer can be a polystyrene or polystyrene derivative with the scavenger units as side chain groups. Thus, in the present example, a methyl-substituted naphthalene is bound to the matrix polymer via an alkyl spacer group. Alternatively, the spacer group can be an alkyl ether or an alkyl ester group.

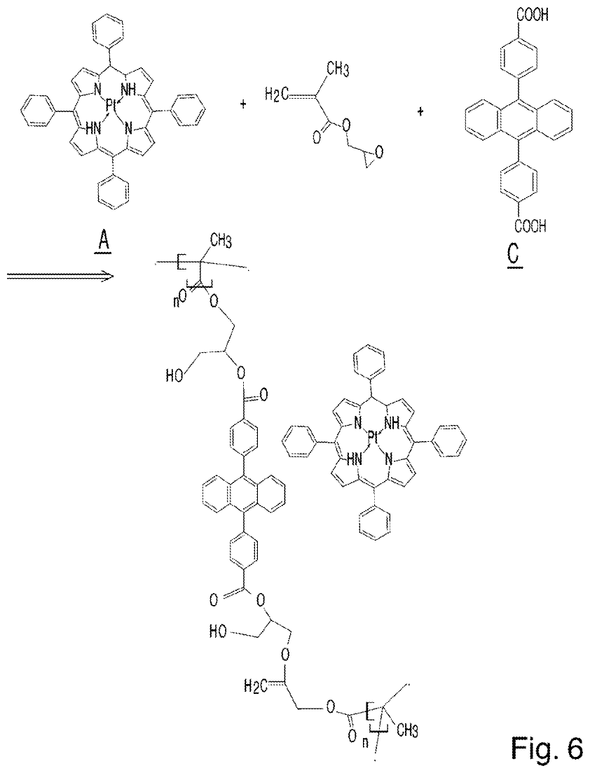

FIG. 6 shows a second example of a polymer matrix modified with scavenger units for the reversible binding of singlet oxygen. Here, a polycyclic aromatic compound is again selected for the reversible binding of singlet oxygen, specifically the anthracene-based dicarboxylic acid C. The scavenger units are not provided here as functional side groups of the polymer, as in the previously described example, but serve in an additional function as crosslinkers for the polymer forming the polymer matrix of the sensitive layer 4. To prepare sensitive layer 4, platinum porphyrin complex A, which serves as a luminescent dye, is added during polymerization of 2,3-epoxypropyl methacrylate and dicarboxylic acid C, which serves as a crosslinker. In this exemplary embodiment, the anthracene units linked via ester groups to the methacrylate chains of the matrix polymer thus formed serve as scavenger units and, quite analogously to the exemplary embodiment described with reference to FIG. 4, bind singlet oxygen as endoperoxide via a [4+2] cycloaddition and release it again upon an increase in temperature or pressure.

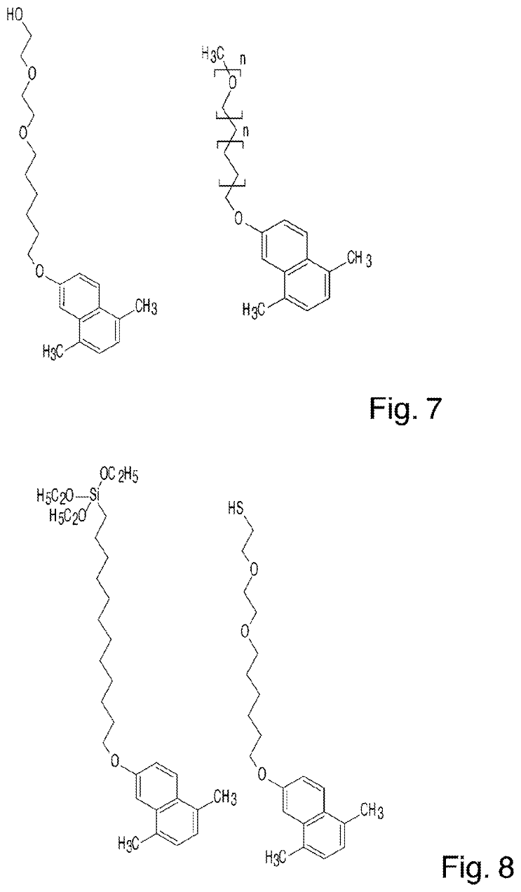

In another embodiment, the luminescence indicator can be encapsulated in micelles or core-shell structures. The scavenger units for reversible binding of singlet oxygen can be bound to the micelle material in such embodiments. Preferably, they are bound to the non-polar chain end of the molecules forming the micelles, as exemplified in FIG. 7. In this case, the scavenger units are arranged inside the micelle and thus separated by the micelle membrane from, for example, the polar measuring fluid, for example water or aqueous solutions. This reduces the risk of contamination of the measuring fluid by the scavenger units.

Alternatively, the scavenger units can be bound to SAM-forming molecules with siloxane end group or thiol end group via aliphatic chains as spacers. Such monomers can form a monolayer or a plurality of superimposed layers on a transparent substrate of the sensor element, in which the luminescence indicator is integrated. Examples of suitable SAM-forming molecules functionalized with scavenger units are shown in FIG. 8.

Alternatively, the SAM-forming molecules can be used to form core-shell structures to encapsulate the luminescence indicator, as can the monomers shown in FIG. 7.

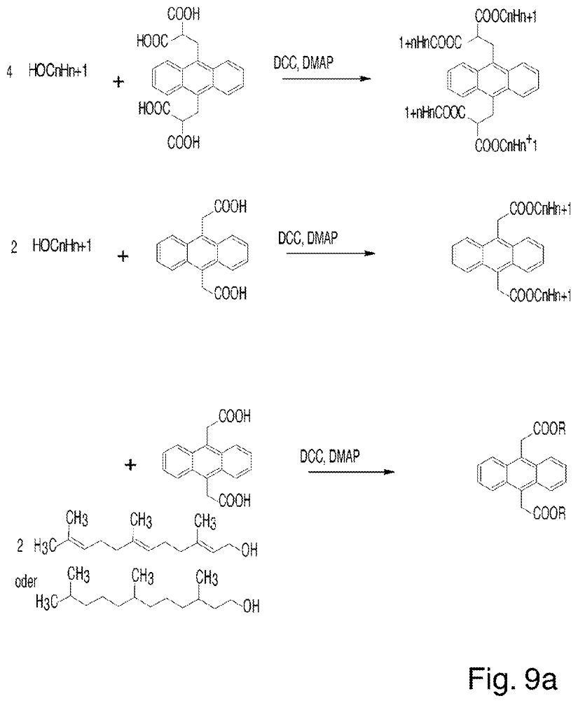

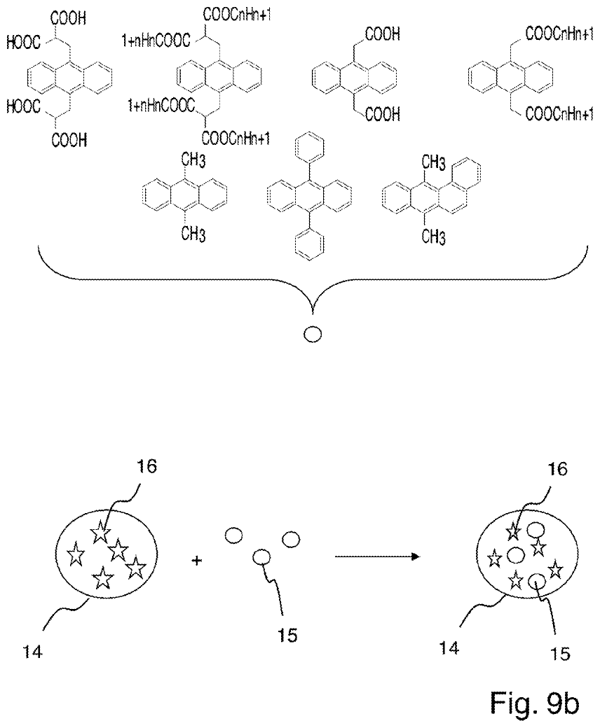

FIGS. 9a and 9b show the formation of core-shell structures and/or micelles with luminescence indicator encapsulated therein and the additional introduction of scavenger units into such structures. Polystyrene beads, for example, can serve as the core-shell structure. The interior of the polystyrene beads is non-polar. It is therefore advantageous to functionalize polycyclic aromatics, which serve as scavenger units, in such a way that they dissolve in or mix with the non-polar matrix of the polystyrene beads. For this purpose, for example, as shown in FIG. 9a, a polycyclic aromatic, in this case anthracene, is functionalized with carboxyl groups and esterified with a longer-chain or branched alcohol by means of Steglich esterification with dicyclohexylcarbodiimide DCC and 4-dimethylaminopyridine DMAP (three examples shown in FIG. 9a).

As shown schematically in FIG. 9b, the polycyclic aromatic esters formed in this way (shown as circles 15 in FIG. 9b), but also other polycyclic aromatic scavenger units, can be introduced into a polystyrene bead 14 with a luminescence indicator encapsulated therein (shown as stars 16 in FIG. 9b). Encapsulation is advantageous to prevent leakage of the luminescence indicator or scavenger units into the measuring fluid.

1. A sensor element for an optochemical sensor, the sensor element comprising:
a luminescence indicator, whose luminescence can be quenched with oxygen; and
scavenger units configured to deactivate singlet oxygen via forming a chemical reaction product by reacting with singlet oxygen,
wherein the scavenger units are selected to be recovered by a decomposition reaction, which decomposition reaction is induced thermally, photochemically, or by a pressure increase of the chemical reaction product formed by the reaction with singlet oxygen.

2. The sensor element according to claim 1, further comprising a polymer matrix in which the luminescence indicator is present in the form of a mixture or bound to the polymer matrix or encapsulated in micelles or core-shell structures contained in the polymer matrix.

3. The sensor membrane according to claim 2, wherein the scavenger units are bound to the polymer matrix.

4. The sensor element according to claim 1, wherein the scavenger units are bound to the luminescence indicator.

5. The sensor element according to claim 1, wherein:
the sensor element includes micelles in which the luminescence indicator is encapsulated; and
the scavenger units are bonded to a material comprising the micelles or to the luminescence indicator.

6. The sensor element according to claim 1, wherein:
the sensor element includes core-shell particles in which the luminescence indicator is encapsulated; and
the scavenger units are bonded to a material comprising a shell of the core-shell particles or to the luminescence indicator.

7. The sensor element according to claim 6, wherein the scavenger units are bonded to a polymer forming the shell of the core-shell particles.

8. The sensor element according to claim 1, wherein:
the sensor element includes a self-assembled monolayer (SAM) of surface-active molecules; and
the scavenger units are bound to at least a portion of the surface-active molecules comprising the SAM or to the luminescence indicator.

9. The sensor element according to claim 1, wherein the scavenger units bind singlet oxygen as endoperoxide.

10. The sensor element according to claim 9, wherein the scavenger units are selected from: substituted benzene derivatives, naphthalene, naphthalene derivatives, acenes, substituted acenes, acene derivatives.

11. The sensor element according to claim 10, wherein the scavenger units are acenes selected from: anthracene, tetracene, pentacene and hexacene.

12. The sensor element according to claim 10, wherein the scavenger units are acene derivatives with methyl, phenyl, pyridinyl, alkynyl, or tetramethylsilane as substituents.

13. The sensor element according to claim 1, wherein the luminescence indicator is a metal-porphyrin complex, or an iodinated BODIPY, a metal-phthalocyanine, a halo(iodo)triangulenium complex, a platinum-organic complex, ruthenium phenanthroline, difluoroboron and aluminum chelate of 9-hydroxyphenalenone or a benzannelized derivative of 6-hydroxybenz[de]anthracen-7-one.

14. An optochemical sensor for measuring a measured variable representing the concentration of oxygen or a reactive oxygen-containing species in a measuring medium, the optochemical sensor comprising:
a sensor element according to claim 1;
a radiation source configured to excite the luminescence indicator to emit luminescence radiation; and
a detector configured to record at least one optical property of the luminescence indicator.
